(19) United States
(12) Patent Application Publication
(10) Pub. No.: US 2004/0254660 A1
(43) Pub. Date: Dec. 16, 2004

(54) Method and device to process digital media streams

(76) Inventor: Alan Seefeldt, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/447,671

(22) Filed: May 28, 2003

(51) Int. Cl. G06F 17/00

(52) U.S. Cl. 700/94

(57) ABSTRACT

A method and device to process at least two audio streams is provided. The method includes adjusting a tempo of at least one of the audio streams, and processing the audio streams to obtain a phase difference between the audio streams. Thereafter, the tempo of the adjusted audio stream is re-adjusted in response to the phase difference. The method may include repetitively re-adjusting the tempo of at least one of the audio streams to reduce any lead and lag. In one embodiment, the method includes determining an energy distribution of each audio stream, and comparing the energy distributions of the at least two audio streams. The tempo of at least one of the audio streams may be re-adjusted in response to the comparison. In one embodiment, a cross-correlation analysis and an autocorrelation analysis is used to beat match two or more audio streams.

### FIELD OF THE INVENTION

This invention relates to processing digital media streams. In particular, the invention relates to a method and device to process two or more media streams such as audio streams.

### BACKGROUND

Conventionally, in order to match the beats of two independent audio streams, tempo and beat detection of the audio streams may be automatically performed. Given an audio signal, for example, a .wave or a .aiff file on a computer, or a MIDI file (e.g., as recorded on a computer from a keyboard), a first task in beat matching the two audio signals is performed to determine the tempo of the music (the average time in seconds between two consecutive beats). Thereafter, a second task is performed in which the downbeat (the starting beat) of each audio stream is located. Once this has been accomplished, the audio streams may be processed to align the downbeats of the two audio streams so that two audio streams are both tempo matched and beat aligned. However, current technology only effectively matches the beats of two independent audio streams that have constant beat tempi.

### SUMMARY OF THE INVENTION

In accordance with the invention, there is provided a method to process at least two audio streams, the method including:

adjusting a tempo of at least one of the audio streams;

processing the audio streams to obtain a phase difference between the audio streams; and

re-adjusting the tempo of the adjusted audio stream in response to the phase difference.

The phase difference may define one of a lead and a lag between the audio streams, the method including repetitively re-adjusting the tempo of at least one of the audio streams to reduce any lead and lag.

Processing the audio streams may include:

determining an energy distribution of each audio stream;

comparing the energy distributions of the at least two audio streams; and

adjusting the tempo of at least one of the audio streams in response to the comparison.

In one embodiment, the energy distribution may be derived from a Short-Time Discrete Fourier Transform of the audio stream. The method may include performing a cross-correlation of the energy distributions, the tempo of the at least one audio stream being adjusted in response to the cross-correlation.

The re-adjusting of the tempo of at least one of the audio streams may include time scaling the audio stream. The tempo of the audio stream may be re-adjusted by modulating a time scale factor.

In one embodiment, one of the audio streams defines a reference audio stream, the method including time scaling all other audio streams to match a tempo of the reference audio stream.

The method may include:

performing a coarse estimation of a phase difference between the audio streams;

adjusting the two audio streams relative to each other using at least one buffer arrangement to obtain coarsely matched audio streams; and

re-adjusting the tempo of at least one of the coarsely matched audio streams.

The method may include:

determining an energy distribution of each audio stream; and

at least estimating a tempo of each audio stream from its associated energy distribution; and

adjusting the tempo of at least one of the audio streams based on the tempo estimate.

The method may include performing an autocorrelation analysis on the energy distribution and estimating the tempo of the audio stream from the autocorrelation analysis. In one embodiment, the method includes estimating a number of beats per minute (BPM) from the autocorrelation analysis to obtain the tempo. A Short-Time Discrete Fourier Transform may be performed on at least one audio stream, the tempo of the audio stream being adjusted in response to the Short-Time Discrete Fourier Transform.

Further in accordance with the invention, there is provided a method of beat-matching at least two audio streams, the method including:

determining an energy distribution of at least one audio stream;

performing a correlation analysis on the energy distribution; and

processing the audio streams dependent upon the correlation analysis to beat-match the at least two streams.

The method may include:

determining an autocorrelation of the energy distribution of at least one of the audio streams; and

estimating a tempo of the audio stream from the autocorrelation.

In one embodiment, the method includes determining a cross-correlation between the energy distributions; and aligning the tempi of at least two of the audio streams dependent upon the cross-correlation. The tempi may be aligned by repetitively adjusting the tempo of at least one of the audio streams by time scaling the audio stream.

The invention extends to a device to process at least two audio streams and to a machine-readable medium embodying a sequence of instructions that, when executed by the machine, cause the machine to execute any one of the methods described herein.

Other features of the present invention will be apparent from the accompanying drawings and from the detailed description which follows.

### BRIEF DESCRIPTION OF THE DRAWINGS

An embodiment of the invention is now described, by way of example, with reference to the accompanying diagrammatic drawings.

In the drawings,

FIG. 1 shows a schematic architectural overview of an audio processing module, in accordance with the invention, to process two audio streams;

FIG. 2 shows a schematic flow diagram of a method, in accordance with one aspect of the invention, to process two audio streams;

FIG. 3 shows a schematic block diagram of an exemplary playback module, in accordance with another aspect of the invention, for beat matching, mixing, and crossfading two audio streams;

FIG. 4 shows a schematic block diagram of an exemplary crossfade controller state machine;

FIG. 5 shows a schematic block diagram of a further embodiment of an audio processing module, in accordance with the invention, to process two audio streams;

FIG. 6 shows a schematic flow diagram of an exemplary method, in accordance with an aspect of the present invention, for providing coarse and fine beat matching; and

FIG. 7 shows a schematic block diagram of an exemplary computer system for implementing the invention.

### DETAILED DESCRIPTION

A device and method is provided to process multiple digital media streams. In one embodiment, when the digital media streams are digital audio streams wherein each stream has a steady beat, the tempo of each audio stream (e.g., beats per minute (BPM)) is continuously measured over time. The measured tempi are then used in conjunction with a set of time scalers to adjust each audio stream to a common tempo. The common tempo may, for example, be derived from the BPM of one stream designated as a “master” or reference stream, or it may be set independently by an external clock. After the audio streams have been set at the same (or substantially the same) tempo, a measure of phase error between each audio stream (or the external clock) is computed at regular intervals. The phase error is then used to modify the time scaler of at least one of the audio streams, thereby to bring the audio stream into phase with the master stream (or the external clock) over a prescribed time interval. Thus phase correction is achieved by modifying the time scalers rather than by shifting the streams in time to align downbeats and, accordingly, a reduced number of audible glitches, if any, may be heard as a result of the phase correction.

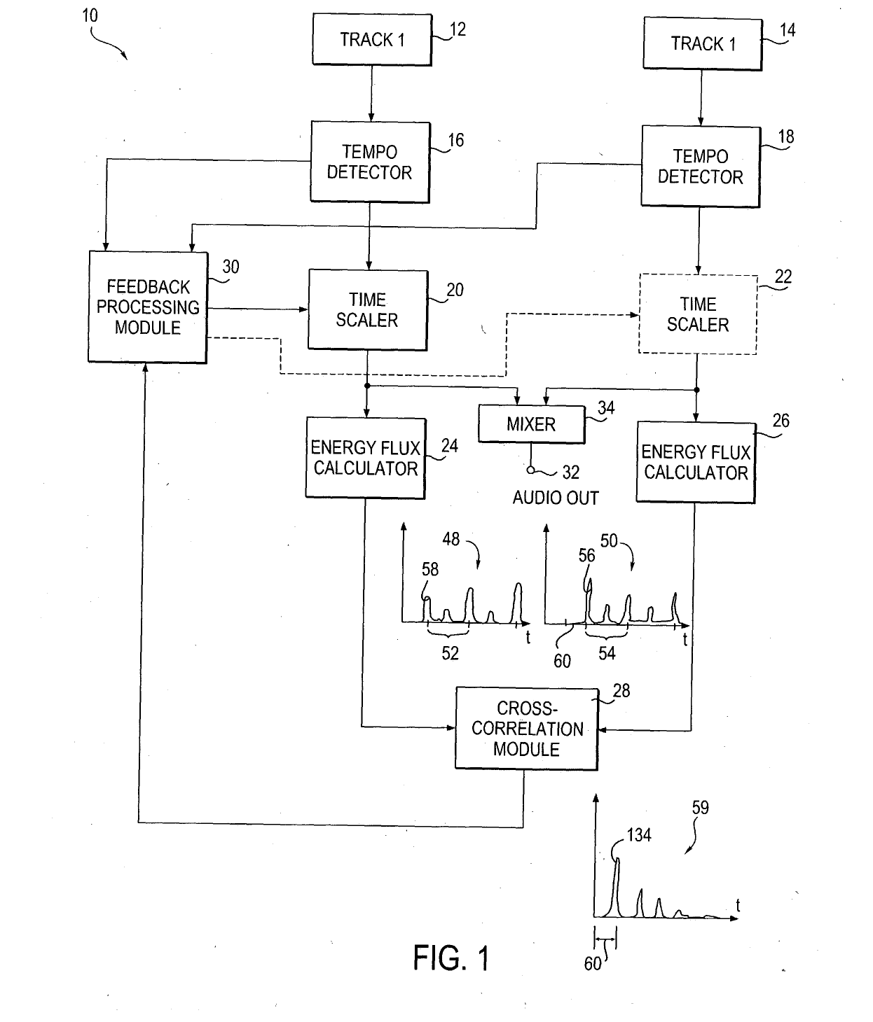

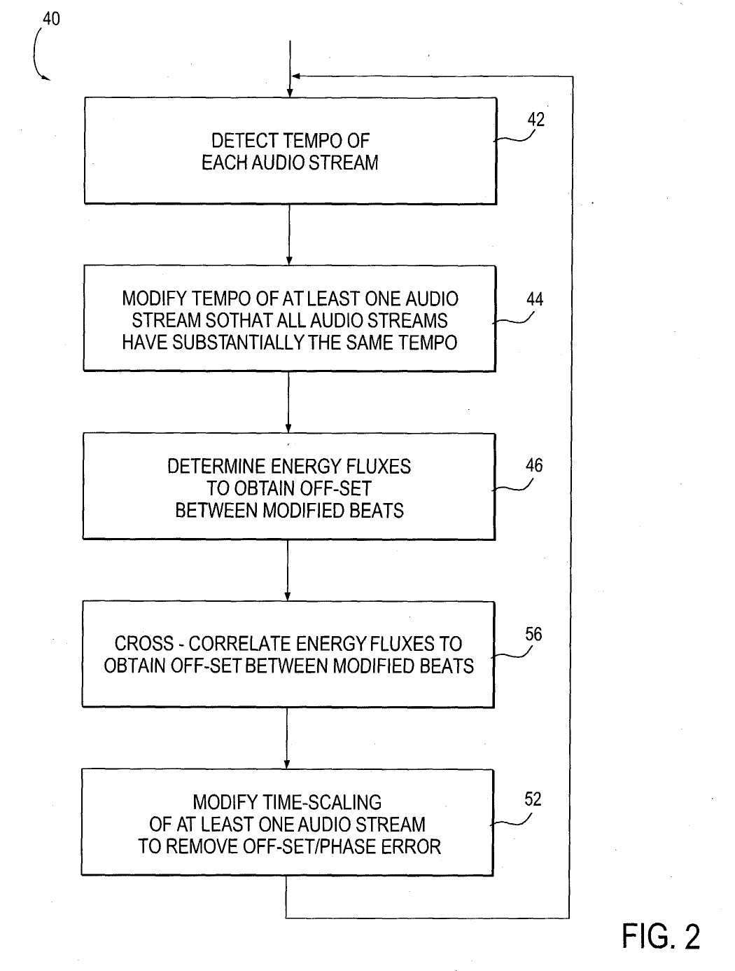

Referring in particular to FIGS. 1 and 2 of the drawings, reference numeral 10 generally indicates an audio processing module or device in the exemplary form of a beat matching module, in accordance with one aspect of the invention, for processing a first and a second audio stream. The first audio stream is shown as an audio track 12, and the second audio stream is shown as an audio track 14, both of which are digital audio streams.

The audio tracks 12 and 14 are fed into substantially similar or symmetrical legs of the beat matching module 10. In particular, the legs include tempo detectors 16, 18, a time scaler 20, an optional time scaler 22, and energy flux calculators 24, 26. Outputs from the energy flux calculators 24, 26 are fed into a cross-correlation module 28 that estimates a phase error between the track 12 and track 14. The phase error (lead/lag) from the cross-correlation module is then fed into a feedback processing module 30. The feedback processing module 30 also receives tempo detection data from the tempo detectors 16, 18 and, in response to the phase error and the tempo detection data, adjusts the time scaling of the time scaler 20 thereby to perform beat matching and phase alignment of the two audio streams. An output 32 of the beat matching module 10 is provided by a mixer 34 that operatively combines the tracks 12, 14 after they have been time scaled. The time scaler 22 need not be included in all embodiments and, when included, the feedback processing module 30 may then adjust the tempo of track 12 and/or track 14, as required. In this regard, it is important to bear in mind that the two tracks 12, 14 are time scaled relative to each other and that either one of the tracks 12, 14 or both of the tracks 12, 14 may be adjusted to reduce the phase error between the two tracks 12, 14.

Referring in particular to FIG. 2, reference numeral 40 generally indicates a method, in accordance with one aspect of the invention, for processing two audio streams (e.g., two audio tracks). The method 40 may be preformed by the beat matching module 10 and, accordingly, is described with reference to the module 10. As shown at block 42, the method 40 commences by detecting the tempo of each or track 12, 14 using the tempo detectors 16, 18. Thereafter, the tempo of at least one of the tracks 12, 14 is modified so that both the tracks 12, 14 have substantially the same tempo (see block 44). It is, however, to be appreciated that the invention is not limited to processing only two audio streams and the beat matching module 10 may thus include one or more further legs for one or more further audio streams. In order to modify the tempo of each audio stream, the time scalers 20, 22 may be used. Thereafter, as shown at block 46, an energy flux for each audio stream is calculated (see energy flux calculators 24, 26). Exemplary energy distributions for the tracks 12, 14 are generally indicated by reference numerals 48, 50 respectively in FIG. 1.

Although the exemplary embodiment illustrates calculation of a energy flux, it is to be appreciated that any signal distribution can be used on which a cross-correlation analysis may be performed. For example, the energy distribution may be in the form of a power spectral density, energy spectral density, or the like.

Once the tempi of the tracks 12 and 14 have been matched, a tempo 52 of track 12 is substantially equal to a tempo 54 of track 14 (see FIG. 1). However, although the tempi 52, 54 have been matched, they are not necessarily beat aligned or synchronized. For example, the inception of a new beat 56 of the track 14 may lag (or lead) the inception of a new beat 58 of the track 12. Thus, the energy fluxes of the tracks 12 and 14 are then cross-correlated (see block 56) to obtain a cross-correlation 59 between the tracks 12 and 14. The cross-correlation 59 is determined by the cross-correlation module 28 and provides an estimation of the offset or phase error 60 between the two audio streams 12, 14.

As shown at block 62, the time scaling of at least one of the time scalers 20, 22 is then adjusted by the feedback processing module 30 thereby to align the inception of the beats 56 and 58. It will thus be appreciated that the beats 56 and 58 are aligned by adjusting the time scaling of an audio stream based on the cross-correlation between two audio streams and not by detecting a downbeat of each track 12, 14. Accordingly, a phase difference or error between the two audio streams may be monitored and used to align the beats of the two audio streams or tracks 12, 14.

The processing module 10 may form part of any audio signal processing equipment where two or more audio signals require beat matching. However, an exemplary embodiment in which the beat matching module 10 defines a plug-in component of a playback module in a digital music processing system is now described by way of example.

Exemplary Modular Implementation

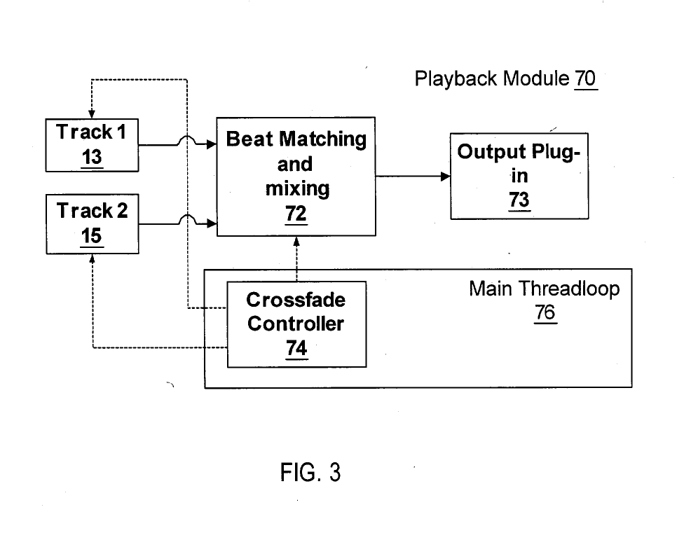

Reference numeral 70 (see FIG. 3) generally indicates exemplary architecture of a playback module to implement the method 40 of FIG. 2. The module 70 may be included in any digital music processing system or equipment in order to select and mix digital audio streams. For example, the playback module 70 may provide a means of synchronizing multiple rhythmic audio streams so that playback of the two streams is at substantially the same tempo so that the audio streams have their beats aligned in time. Unlike prior art technology, the module 70 allows audio streams whose tempi do not remain constant over time to be synchronized. For example, the playback module 70 can be used to create substantially seamless transitions from one audio track to the next, similar to music track transitions provided by a DJ in a club. Also, because the playback module 70 can operate on audio streams in real time, it can be used to synchronize a prerecorded digital audio track with a live performer (for example, a drummer).

In one embodiment, the module 70 is in the form of a software plug-in that includes various components that may also be configured as plug-ins. The module 70 is shown to include a beat matching and mixing component 72 (which may substantially resemble the beat matching module 10) and the audio streams 12, 14 may be provided by audio stream or track plug-in components 13, 15. The beat matching and mixing component 72 receives two audio streams (e.g., audio tracks) 12, 14 from the audio stream plug-in components 13, 15 that it synchronizes and combines into a single output using a plug-in component 73. The playback module 70 is responsive to a crossfade controller 74 that is shown to form part of a main threadloop 76. In use, the crossfade controller 74 selectively fades one or both of the audio streams 12, 14 fed into the playback module 70. It is to be appreciated that more than two audio plug-in components may be provided in the playback module 70.

As mentioned above, the playback module 70 may process two or more digital audio streams or tracks 12, 14. Accordingly, the playback module 70 maintains pointers to a “current track”, which identifies an audio stream (e.g., a song) that a user is currently hearing, and a “next track”, which identifies an audio stream (e.g., a song) that will be played next by a system including the module 70. When the playback module 70 switches between (e.g., crossfades) the two audio streams 12, 14, the “current track” and the “next track” pointers may switch between digital audio tracks sourced via the plug-in components 13, 15. In order to provide continuous playback of the audio tracks 12, 14, the playback module 70 may always attempt to keep current track and next track buffers filled with an audio stream provided by an audio file. For example, requests may be made to an external playlist for new tracks when they are needed.

In one embodiment, from an initial state when both the current track and the next track are empty, the following playback functionality may be executed by the playback module 70 after it receives a play command or message:

1. Make a request to the playlist to fill a current track and a next track.

2. Fill the current track and the next track with digital audio data.

3. Begin Playback of the current track.

4. Begin Crossfade into the next track.

5. End Playback of the current track.

6. The next track becomes the current track and continues playing.

7. Make request to the playlist to fill the next track.

8. Fill the next track.

9. Goto step 4.

During the above exemplary functionality, if a user decides to crossfade to an audio stream or track other than the one currently loaded into the playback module 70 as the next track, a message can be sent to the playback module 70 to clear the currently loaded next track. After this, the playback module 70 will then identify that the next track is empty, and a new request to fill the next track may be made to the playlist. The playlist may then pass back a reference to the desired next track.

Crossfade Controller

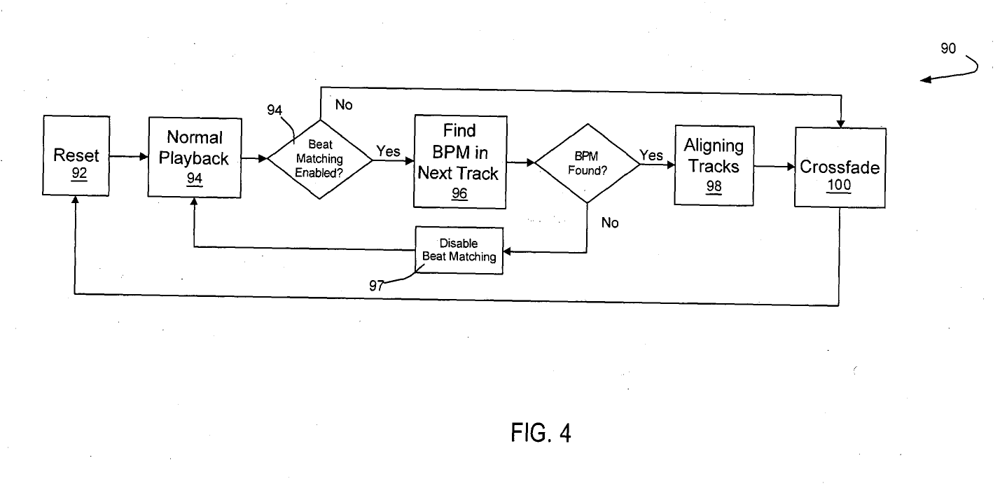

Reference numeral 90 generally indicates an exemplary state machine (see FIG. 4) of the crossfade controller 74. The state machine 90 includes the following five exemplary states:

1. A Reset state 92;

2. A Normal Playback state 94;

3. A Find BPM in Next Track state 96;

4. An Align Tracks state 102; and

5. A Crossfade state 100.

Transitions from one state to the next may be governed by a combination of the playback position of current track and parameters loaded into an optional XFX preset module. For presets that do not enable beat matching, the loop through the state machine may be as follows:

Reset 92->Normal Playback 94->Crossfade 100->Reset 92.

In one embodiment, during the Crossfade state 100, all of the parameter trajectories defined in the XFX preset module (amplitude, time scale, pitch, etc.) may be applied inside the beat matching and mixing plug-in component 72.

XFX presets that enable beat matching may require passing through two extra states of the crossfade controller 74. In particular, the Find BPM in Next Track state 96 and the Align Tracks state 98 may also be passed through. In the Find BPM in Next Track state 96, the crossfade controller 74 may search for a valid BPM in the next track while a current track is playing. The crossfade controller 74 may then be allotted a fixed amount of real-time playback to search faster than real-time into the next track. The crossfade controller 74 may also be given a maximum track position in next track past which it is not allowed to search. In one embodiment, the crossfade controller 74 is given 20 real-time seconds to search up to 60 seconds into the next track to find its tempo (in BPM). If the crossfade controller 74 is unable to find the BPM of the next track within this time constraint, or if current track does not contain a valid BPM, beat matching may be disabled (see block 97) in the XFX preset module and the crossfade controller 74 may then return to the Normal Playback state 94. Otherwise, the crossfade controller 74 may then proceed to the Align Tracks state 98. In this state, the next track may be time scaled so that its BPM matches that of the current track. As mentioned above, a cross-correlation between the two tracks may then performed for a fixed amount of real-time playback. At the end of this time period, an accumulated cross-correlation is used to determine the optimal phase alignment between the two tracks. As described above, the next track may then be shifted in time to achieve this alignment, and then the crossfade controller 74 may then proceed to the final Crossfade state 100. During the Crossfade state 100, the BPM of the mixed audio streams may then be interpolated from that of current track to that of the next track.

Exemplary Modular Beat Matching and Mixing Plug-in

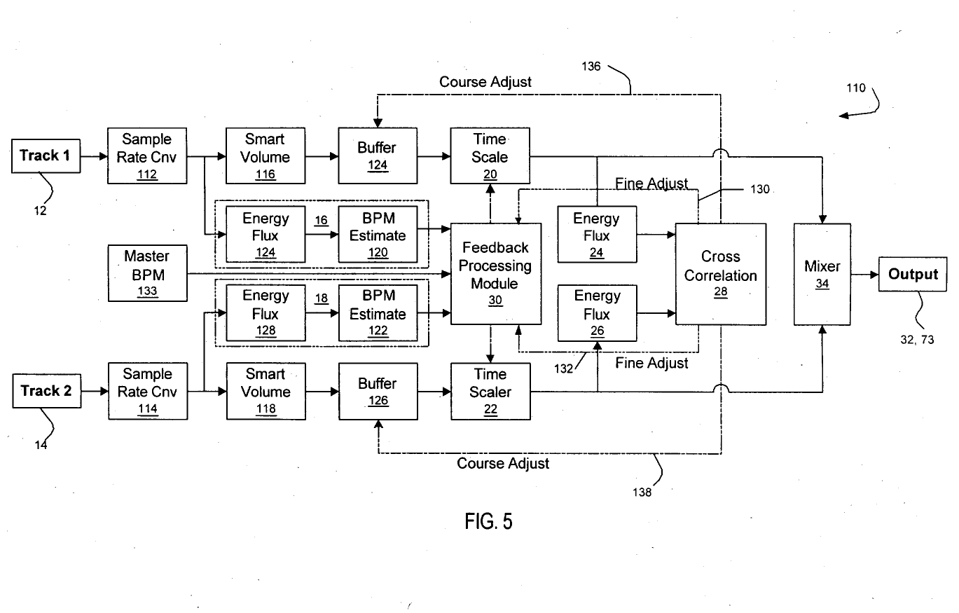

Referring in particular to FIG. 5, reference numeral 110 generally indicates an embodiment of an audio processing module in the exemplary form of a beat matching module, in accordance with the invention. The beat matching module 110 resembles the beat matching module 10 and, accordingly, like reference numerals have been used to indicate the same or similar features unless otherwise indicated. In one embodiment, the beat matching module 110 may be used as the beat matching and mixing component 72 of the playback module 70, and its use in this exemplary application is described in more detail below.

The beat matching module 110 includes a plurality of functional components and pathways arranged in two symmetrical legs that each receive an audio stream shown as audio tracks 12, 14. Each track 12, 14 passes through a sample rate converter 112, 114 respectively and, in this exemplary embodiment, the tracks 12, 14 are mixed at a common sample rate of 44.1 kHz. Further, each track 12, 14 optionally passes through an associated smart volume filter 116, 118 so that they can be mixed at appropriate volume levels.

When used as the beat matching and mixing component 72, during the Normal Playback state 94 described above, only the pathway or leg in the module 110 corresponding to a current track may be active and, during the Finding BPM in Next Track state 96, the pathway corresponding to a next track runs through its associated BPM estimator 120, 122 of an associated tempo detector 16, 18 respectively. During the Align Tracks state 98, an entire associated leg may be active and the next track may not be mixed into an output audio stream at the output 32, 73. At the end of the Align Tracks state 98, the cross-correlation module 28 provides a lead/lag estimation to buffers 124, 126. In response to the lead/lag estimation, the buffers 124, 126 shift the next track and the current track thereby to match the beats of the two tracks 12, 14. During the Crossfade state 110, if beat matching is enabled, the cross-correlation between the current track and the next track may continue to be computed, and a resulting estimate of the phase error between the tracks is fed back to a time scaler 20, 22 of next track thereby to keep the two tracks in phase.

In addition to enabling beat matching between the tracks 12, 14, the time scalers 20, 22 are used to apply the time scale and pitch trajectories of the XFX preset module to both the current track and the next track. All other XFX parameter trajectories (e.g., amplitude, low and high frequency cutoff) may be handled by the mixer 34, which mixes the two tracks 12, 14 in the frequency domain and provides a single time-domain output.

It will be noted that, in the exemplary beat matching module 110, tempo detection (BPM detection) and phase alignment are separated and performed independently. Further, unlike conventional tempo detection techniques that use a downbeat (foot tapping) to perform beat matching, the beat matching module 110 does not require time domain detection of a downbeat to match the beats of the two tracks 12, 14. In particular, tempo detectors 16, 18 include energy flux modules 124, 128 and BPM estimators 120, 122 respectively to match the beats of the two audio tracks 12, 14. In one embodiment, the tempo of each track 12, 14 can be extracted using an autocorrelation measure. As this is a one-dimensional process integrating beat matching and beat offset determination, it may thus have cost advantages.

Regarding the alignment of the beats of the audio tracks 12, 14, rather than using downbeat estimates from the two tracks 12, 14 to align them in phase, the beat matching module 110 instead uses the cross-correlation module 28 to compute a cross-correlation between the two tracks 12, 14 after they have been time scaled to be at the same tempo. The cross-correlation analysis utilizes the inherent structure of each track 12, 14 to achieve an alignment, which allows it to align beat 1 of track 12 with beat 1 of track 14. If prior art technology is used for downbeat estimation, beats would be aligned, but not necessarily beat 1 with beat 1 because these estimates contain no information about measure structure. For example, using prior art techniques a beat 1 of track 12 is as likely to be aligned with beat 1 as it is with beat 4 of track 14. In addition, in the beat matching module 110, the cross-correlation is continuously monitored in the feedback processing module 30 to determine if the two tracks 12, 14 are falling out of phase, for example, due to small errors in the tempo estimates or rhythmic variations in the tracks 12, 14. This error is then be fed back by the cross-correlation module 28 to the time scalers 20, 22 (see lines 130, 132 in FIG. 5) thereby to modulate either time scaler 20, 22 so that the tracks 12, 14 are brought back into phase without any audible glitches.

Energy Flux Signal

In the beat matching module 110 shown in FIG. 5, two energy flux modules 24, 124 and 26, 128 are provided to process each audio stream or tracks 12, 14 respectively. In particular, energy flux signals are fed into the tempo (BPM) estimators 120, 122 and the cross-correlation module 28. The energy flux signal fed into the BPM estimators 120, 122 are used to estimate the tempo of each audio stream or track 12, 14 independently of any phase alignment. However, the energy flux signals fed into the cross-correlation module 28 are used to align the phases of the two audio signals. In one embodiment, each energy flux signal (see energy distributions 48, 50 of FIG. 1) is derived from a Short-Time Discrete Fourier Transform (STDFT) of an associated audio stream or track 12, 14. Thus, the energy flux signal may be computed over a desired frequency range as follows:

$${e}_{[ a , b ]} [ n ] = h [ n ] * max \{ 0 , \frac{1}{b - a} {\sum }_{w = a}^{b} {\vert X [ n , w ] \vert}^{\frac{1}{2}} - {\vert X [ n - 1 , w ] \vert}^{\frac{1}{2}} \} \qquad ( 1 )$$

where X[n,w] is the Short-Time Discrete Fourier Transform of the associated audio stream or track 12, 14, a is a desired lower frequency bin, b is a desired upper frequency bin, and h[n] is a smoothing filter. In this implementation, the energy flux signal is designed to reveal transients in the audio signal, even those that may be “hidden” in the overall signal energy by higher amplitude continuous tones.

Estimation of the Tempo (BPM)

In one embodiment, the tempo of each track 12, 14 may be estimated from the short-time, zero-mean autocorrelation of its energy flux signal. For example the tempo may be computed as follows:

φₑₑ[n,m]=αφₑₑ[n−1,m]+(1−α)(e[n]−Mₑ[n])(e[n−m]−Mₑ[n]) (2)

where m is the lag, α is a forgetting factor set to achieve a half decay time of D seconds, and Mₑ[n] is the short-time mean of e[n]. The forgetting factor, α, may be computed from the following relationship:

$${α}^{\frac{{F}_{s}}{hop} D} = 0.5 \qquad ( 3 )$$

where Fₛ is the sample rate in Hz and hop is the hop size of the STDFT in samples. The short-time mean Mₑ[n] may updated as follows:

Mₑ[n]=αMₑ[n−1]+(1−α)e[n] (4)

The BPM at time n is then chosen by selecting the lag L which maximizes the following cost function:

$$C [ L ] = {\sum }_{i = 1}^{4} \frac{1}{8} {φ}_{ee} [ n , ( i - \frac{3}{4} ) L ] + \frac{1}{4} {φ}_{ee} [ n , ( i - \frac{1}{2} ) L ] + \frac{1}{8} {φ}_{ee} [ n , ( i - \frac{1}{4} ) L ] + \frac{1}{2} {φ}_{ee} [ n , iL ] \qquad ( 5 )$$

This cost function may accumulate the autocorrelation at sixteenth note locations across four measures for the BPM corresponding to lag L. The lag L may be given by:

$$L = ( \frac{60}{BPM} ) ( \frac{{F}_{s}}{hop} ) \qquad ( 6 )$$

In one embodiment, the cost function may be evaluated for the lags corresponding to tempi ranging from about 73 to about 145 in increments of 1 BPM.

Phase Alignment

In one embodiment, using the BPM estimates for each track 12, 14, the time scalers 20, 22 may be adjusted to set both tracks 12, 14 to a common master BPM provided by a master BPM module 133. It is to be appreciated that the master BPM module 133 may provide a tempo equal to the tempo of either track 12, 14, or an entirely independent tempo set manually by the user or an external control signal. The time-scaling ratio R provided by the feedback processing module 30 may be nominally equal to the ratio of the target BPM delivered by module 133 to the original track BPM measured by modules 120 and 122.

With the tracks 12, 14 adjusted to a common tempo, the cross-correlation module 28 computes the short-time cross-correlation between the two tracks 12, 14, in a similar fashion to the autocorrelation used for the tempo estimates. For example, the cross-correlation may be computed as follows:

φₑ_{₁}ₑ_{₂}[n,m]=αφₑ_{₁}ₑ_{₂}[n−1,m]+(1−α)(e₁[n]−Mₑ_{₁}[n])(e₂[n−m]−Mₑ_{₂}[n]) (7a)

φₑ_{₂}ₑ_{₁}[n,m]=αφₑ_{₂}ₑ_{₁}[n−1,m]+(1−α)(e₂[n]−Mₑ_{₂}[n])(e₁[n−m]−Mₑ_{₁}[n]) (7b)

where e₁[n] and e₂[n] are the energy flux signals for the time scaled tracks, and Mₑ_{₁}[n] and Mₑ_{₂}[n] are their corresponding short-time means.

In order to provide an initial phase alignment of the two tracks 12, 14, the maximum of the cross-correlation over a range of lags corresponding to four beats may be found. For example, if track 14 is to be shifted relative to track 12, the maximum shift may be found in φₑ_{₁}ₑ_{₂}[n], and if track 12 is to be shifted relative to track 14, then φₑ_{₂}ₑ_{₁}[n] may be used. The appropriate track 12, 14 may then be shifted backwards by an amount equal to the lag at which the cross-correlation achieves its maximum 134 (see in FIG. 1). In the beat matching module 110 the shift happens before the time scalers 20, 22 and, accordingly, the shift amount must first be scaled by the inverse of an associated time-scale factor.

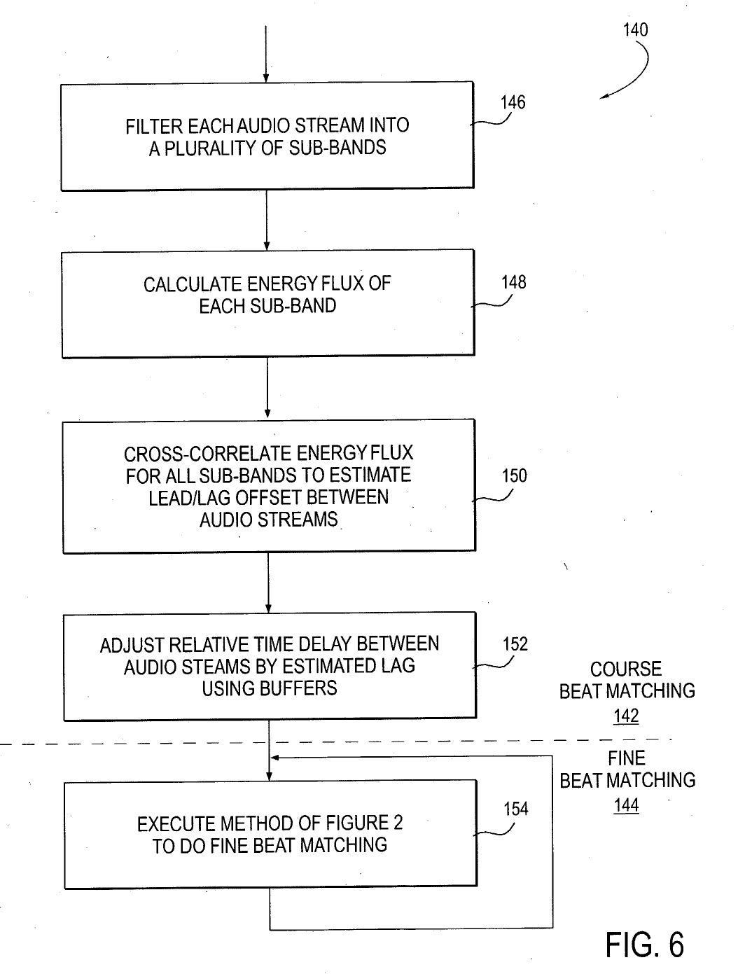

In one embodiment of the beat matching module 110, the tempi of the tracks 12, 14 are matched in a coarse and a fine fashion. Referring to FIG. 6, reference numeral 140 generally indicates a method of beat matching in accordance with one embodiment of the invention. The method 140 initially performs coarse beat matching 142 approximately to match the beats of the two tracks 12, 14 and, thereafter, performs fine beat matching 144 substantially to match the beats. In particular, as shown at block 146, the tracks 12, 14 may be filtered into a plurality of appropriate sub-bands whereafter the energy flux (see FIG. 1) for each sub-band is calculated by the energy flux calculators 24, 26, as shown at block 148. In a similar fashion to that described above, the cross-correlation module 28 cross-correlates the flux for all sub-bands to estimate a lead/lag offset between the two tracks 12, 14 (see block 150). Then, in order to coarsely align the two tracks 12, 14, the estimated lead/lag offset is fed back (see lines 136, 138) into the buffers 124, 126 which then adjust a relative delay between the tracks (see block 152). The coarse beat matching may be performed once initially to approximately match the beats of the tracks 12, 14.

Once the beats of the two tracks 12, 14 have been matched approximately, then fine beat matching 144 may be repetitively performed as shown at block 154. Once the two tracks 12, 14 are aligned in phase, they may drift out of phase due to small errors in the tempo estimates, or rhythmic variations in the tracks 12, 14 themselves. Thus, in order to keep the tracks 12, 14 in phase, a phase error is repetitively computed from the cross-correlation (see Equation 7), as set out above. Again, depending on which track 12, 14 is to be shifted, the error may be computed from either φₑ_{₁}ₑ_{₂}[n] or φₑ_{₂}ₑ_{₁}[n]. If the two tracks 12, 14 are in phase, then the peak of the cross-correlation should occur at a lag corresponding to one beat interval, L_{BPM} (see lag 60 in FIG. 1). Accordingly, a lag Lₑ may be calculated corresponding to the largest peak 134 (see FIG. 1) of the cross-correlation 59 and within a lag range of L_{BPM}±¼L_{BPM}. The normalized phase error may then be computed as follows:

$${E}_{p} = \frac{{L}_{e} - {L}_{BPM}}{{L}_{BPM}} \qquad ( 8 )$$

This phase error could be used to immediately shift the appropriate track 12, 14 by an amount that brings both tracks 12, 14 back in phase. However, this may cause a glitch in the output audio every time the phase is corrected. Thus, the error may be used instead to modulate the time scaler 20, 22 of the appropriate track 12 14 by an amount that brings the tracks 12, 14 back in phase over the duration of one beat. More specifically, in one embodiment a time scale factor R described above is multiplied by 1+Eₚ for a duration of (1+Eₚ)(60/BPM)(Fₛ/hop) seconds. After this timed modulation is applied, the phase error is allowed to accumulate over another beat interval, whereafter the correction process is repeated. Thus, the feedback processing module 30 may be a multiplier that multiplies time scaling ratio R by a ratio equal to 1+Eₚ for the above mentioned duration.

The discussion above describes how the cross-correlation module 28 may be used for two purposes. Firstly, an initial or coarse phase alignment is accomplished over, for example, one 4 beat measure and, secondly, phase correction is accomplished through error feedback. In certain embodiments, the beat matching module 110 may perform more favorably when two different cross-correlation calculations are used for the coarse and fine alignment mentioned above. Accordingly, in one embodiment, for initial alignment, a cross-correlation function with a large forgetting factor (see Equation 2 above) may be used. The half decay time of α may be set to be 16 beat intervals. Accordingly, variations at the measure level may be averaged. For phase correction, in one embodiment α is set to be only 3 beat intervals so that the beat matching module 110 can react quickly to rhythmic variations in the tracks 12, 14.

As mentioned above with reference to the method 140, in one embodiment initial phase alignment may be enhanced when a multi-band cross-correlation is computed from multiple band-limited energy flux signals. In these embodiments, Equation 7 may be modified as follows:

$${φ}_{{e}_{1} {e}_{2}} [ n , m ] = {αφ}_{{e}_{1} {e}_{2}} [ n - 1 , m ] + ( 1 - α ) {\sum }_{i = 1}^{N} ( {e}_{1 [ {a}_{i} , {b}_{i} ]} [ n ] - {M}_{{e}_{1 [ {a}_{i} , {b}_{i} ]}} [ n ] ) ( {e}_{2 [ {a}_{i} , {b}_{i} ]} [ n - m ] - {M}_{{e}_{2 [ {a}_{i} , {b}_{i} ]}} [ n ] )$$

where the sum is performed across N bands. In one embodiment, 12 bands are used with a Bark spacing. The multi-band cross-correlation may be more suited to lining up band-limited components of audio streams including, for example, a bass drum, a snare drum, and a hi-hat. For phase correction, the multi-band cross-correlation is not necessary, and a simple full-band cross-correlation may be utilized.

Exemplary Computer System

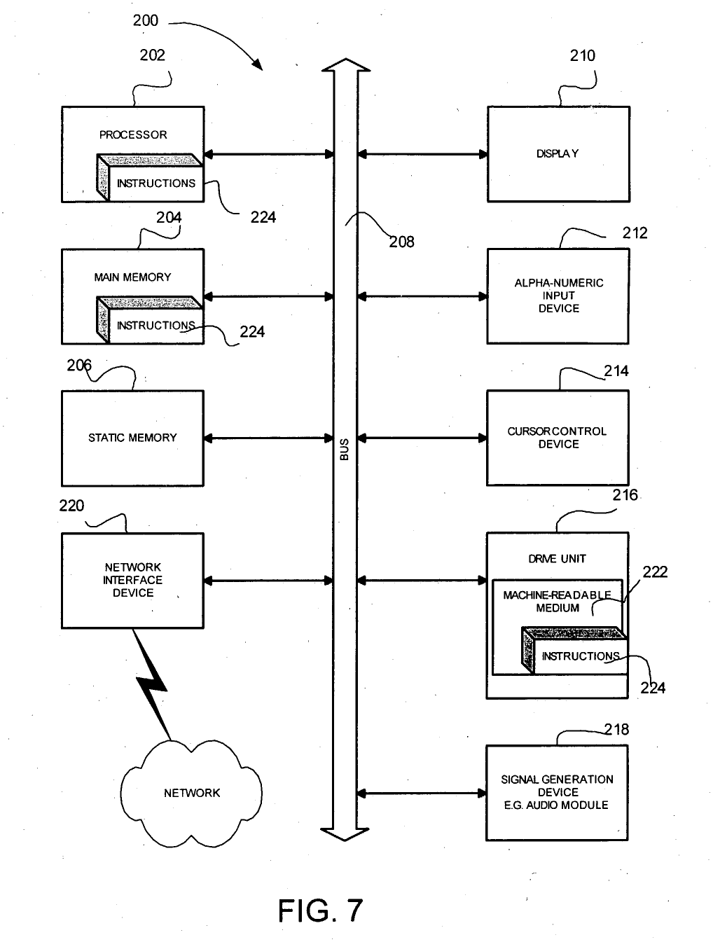

FIG. 7 shows a diagrammatic representation of machine in the exemplary form of the computer system 200 within which a set of instructions, for causing the machine to perform any one of the methodologies discussed above, may be executed. In alternative embodiments, the machine may comprise, a portable audio device (e.g. an MP3 player or the like), a Personal Digital Assistant (PDA), a cellular telephone, a web appliance, a audio processing console, or any machine capable of executing a sequence of instructions that specify actions to be taken by that machine.

The computer system 200 includes a processor 202, a main memory 204 and a static memory 206, which communicate with each other via a bus 208. The computer system 200 may further include a display unit 210 (e.g., a liquid crystal display (LCD), a cathode ray tube (CRT), or the like). In certain embodiments, the computer system 200 also includes an alphanumeric input device 212 (e.g. a keyboard), a cursor control device 214 (e.g. a mouse), a disk drive unit 216, a signal generation device 218 (e.g. an audio module connectable a speaker or any other audio receiving device) and a network interface device 220 (e.g. to connect the computer system 200 to another computer).

The disk drive unit 216 includes a machine-readable medium 222 on which is stored a set of instructions (software) 224 embodying any one, or all, of the methodologies described above. The software 224 is also shown to reside, completely or at least partially, within the main memory 204 and/or within the processor 202. The software 224 may further be transmitted or received via the network interface device 220. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals.

Many other devices or subsystems (not shown) can be also be coupled to bus 208, such as an audio decoder, an audio card, and others. Also, it is not necessary for all of the devices shown in FIG. 7 to be present to practice the present invention. Moreover, the devices and subsystems may be interconnected in different configurations than that shown in FIG. 7. The operation of a computer system 200 is readily known in the art and is not discussed in detail herein. It is also to be appreciated that various components of the system 200 may be integrated and, in some embodiments, the computer system 200 may have a small form factor that renders it suitable as a portable audio device e.g. a portable MP3 player. However, in other embodiments, the computer system 200 may be a more bulky system used as a music synthesizer or any other audio processing equipment.

The bus 208 can be implemented in various manners. For example, bus 208 can be implemented as a local bus, a serial bus, a parallel port, or an expansion bus (e.g., ADB, SCSI, ISA, EISA, MCA, NuBus, PCI, or other bus architectures). The bus 208 may provide high data transfer capability (i.e., through multiple parallel data lines). The system memory 216 can be random-access memory (RAM), dynamic RAM (DRAM), a read-only-memory (ROM), or other memory technology.

When the media files are audio files, each audio file may stored in a digital form and stored on the hard disk drive or a CD ROM and loaded into memory for processing. The processor 202 may execute instructions or program code loaded into memory from, for example, the hard drive and processes the digital audio file to perform functionality including tempo detection, time scaling, autocorrelation calculation, cross-correlation calculation, or the like as described above.

Thus, a method and device to process at least two audio streams have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to process at least two audio streams, the method including:
adjusting a tempo of at least one of the audio streams;
processing the audio streams to obtain a phase difference between the audio streams; and
re-adjusting the tempo of the adjusted audio stream in response to the phase difference.

2. The method of claim 1, wherein the phase difference defines one of a lead and a lag between the audio streams, the method including repetitively re-adjusting the tempo of at least one of the audio streams to reduce any lead and lag.

3. The method of claim 1, wherein processing the audio streams includes:
determining an energy distribution of each audio stream;
comparing the energy distributions of the at least two audio streams; and
adjusting the tempo of at least one of the audio streams in response to the comparison.

4. The method of claim 3, wherein the energy distribution is derived from a Short-Time Discrete Fourier Transform of the audio stream.

5. The method of claim 3, which includes performing a cross-correlation of the energy distributions, the tempo of the at least one audio stream being adjusted in response to the cross-correlation.

6. The method of claim 1, wherein the re-adjusting of the tempo of at least one of the audio streams includes time scaling the audio stream.

7. The method of claim 6, wherein the tempo of the audio stream is re-adjusted by modulating a time scale factor.

8. The method of claim 1, wherein one of the audio streams defines a reference audio stream, the method including time scaling all other audio streams to match a tempo of the reference audio stream.

9. The method of claim 1, which includes:
performing a coarse estimation of a phase difference between the audio streams;
adjusting the two audio streams relative to each other using at least one buffer arrangement to obtain coarsely matched audio streams; and
re-adjusting the tempo of at least one of the coarsely matched audio streams.

10. The method of claim 1, which includes:
determining an energy distribution of each audio stream; and
at least estimating a tempo of each audio stream from its associated energy distribution; and
adjusting the tempo of at least one of the audio streams based on the tempo estimate.

11. The method of claim 10, which includes performing an autocorrelation analysis on the energy distribution and estimating the tempo of the audio stream from the autocorrelation analysis.

12. The method of claim 11, which includes estimating a number of beats per minute (BPM) from the autocorrelation analysis to obtain the tempo.

13. The method of claim 1, which includes performing a Short-Time Discrete Fourier Transform on at least one audio stream, the tempo of the audio stream being adjusted in response to the Short-Time Discrete Fourier Transform.

14. A method of beat-matching at least two audio streams, the method including:
determining an energy distribution of at least one audio stream;
performing a correlation analysis on the energy distribution; and
processing the audio streams dependent upon the correlation analysis to beat-match the at least two streams.

15. The method of claim 14, which includes:
determining an autocorrelation of the energy distribution of at least one of the audio streams; and
estimating a tempo of the audio stream from the autocorrelation.

16. The method of claim 14, which includes:
determining a cross-correlation between the energy distributions; and
aligning the tempi of at least two of the audio streams dependent upon the cross-correlation.

17. The method of claim 16, which includes aligning the tempi by repetitively adjusting the tempo of at least one of the audio streams by time scaling the audio stream.

18. A machine-readable medium embodying a sequence of instructions that, when executed by the machine, cause the machine to:
adjust a tempo of at least one of at least two audio streams;
process the audio streams to obtain a phase difference between the audio streams; and
re-adjust the tempo of the adjusted audio stream in response to the phase difference.

19. The machine-readable medium of claim 18, wherein the phase difference defines one of a lead and a lag between the audio streams, and the tempo of at least one of the audio streams is repetitively re-adjusted to reduce any lead and lag.

20. The machine-readable medium of claim 18, wherein processing the audio streams includes:
determining an energy distribution of each audio stream;
comparing the energy distributions of the at least two audio streams; and
adjusting the tempo of at least one of the audio streams in response to the comparison.

21. The machine-readable medium of claim 20, wherein the energy distribution is derived from a Short-Time Discrete Fourier Transform of the audio stream.

22. The machine-readable medium of claim 20, wherein a cross-correlation of the energy distributions is performed, the tempo of the at least one audio stream being adjusted in response to the cross-correlation.

23. The machine-readable medium of claim 18, wherein the re-adjusting of the tempo of at least one of the audio streams includes time scaling the audio stream.

24. The machine-readable medium of claim 23, wherein the tempo of the audio stream is re-adjusted by modulating a time scale factor.

25. The machine-readable medium of claim 18, wherein one of the audio streams defines a reference audio stream, and all other audio streams are time scaled to match a tempo of the reference audio stream.

26. The machine-readable medium of claim 18, wherein:
a coarse estimation of a phase difference between the audio streams is performed;
the two audio streams are adjusted relative to each other using at least one buffer arrangement to obtain coarsely matched audio streams; and
the tempo of at least one of the coarsely matched audio streams is re-adjusted.

27. The machine-readable medium of claim 18, wherein:
an energy distribution of each audio stream is determined; and
a tempo of each audio stream is at least estimated from its associated energy distribution; and
the tempo of at least one of the audio streams is adjusted based on the tempo estimate.

28. The machine-readable medium of claim 27, wherein an autocorrelation analysis is performed on the energy distribution and the tempo of the audio stream is estimated from the autocorrelation analysis.

29. The machine-readable medium of claim 28, wherein a number of beats per minute (BPM) is estimated from the autocorrelation analysis to obtain the tempo.

30. The machine-readable medium of claim 18, wherein a Short-Time Discrete Fourier Transform is performed on at least one audio stream, the tempo of the audio stream being adjusted in response to the Short-Time Discrete Fourier Transform.

31. A machine-readable medium embodying a sequence of instructions that, when executed by the machine, cause the machine to:
determine an energy distribution of at least one of two audio streams;
perform a correlation analysis on the energy distribution; and
process the audio streams dependent upon the correlation analysis to beat-match the at least two streams.

32. The machine-readable medium of claim 31, wherein:
an autocorrelation of the energy distribution of at least one of the audio streams is determined; and
a tempo of the audio stream is estimated from the autocorrelation.

33. The machine-readable medium of claim 31, wherein:
a cross-correlation between the energy distributions is determined; and
the tempi of at least two of the audio streams are aligned dependent upon the cross-correlation.

34. The machine-readable medium of claim 33, wherein the tempi are aligned by repetitively adjusting the tempo of at least one of the audio streams by time scaling the audio stream.

35. A device to process at least two audio streams, the device including:
at least one time scaler to adjust a tempo of at least one of the audio streams; and
a processor to process the audio streams to obtain a phase difference between the audio streams, wherein the tempo of the adjusted audio stream is re-adjusted in response to the phase difference.

36. The device of claim 35, wherein the phase difference defines one of a lead and a lag between the audio streams, the device repetitively re-adjusting the tempo of at least one of the audio streams to reduce any lead and lag.

37. The device of claim 35, wherein the device:
determines an energy distribution of each audio stream;
compares the energy distributions of the at least two audio streams; and
adjusts the tempo of at least one of the audio streams in response to the comparison.

38. The device of claim 37, which includes cross-correlation module to cross-correlate the energy distributions, the tempo of the at least one audio stream being adjusted in response to the cross-correlation.

39. The device of claim 35, which:
determines an energy distribution of each audio stream; and
at least estimates a tempo of each audio stream from its associated energy distribution; and
adjusts the tempo of at least one of the audio streams based on the tempo estimate.

40. The device of claim 39, which performs an autocorrelation analysis on the energy distribution and estimates the tempo of the audio stream from the autocorrelation analysis.

41. A device to beat-matching at least two audio streams, the device including a processor that:
determines an energy distribution of at least one audio stream;
performs a correlation analysis on the energy distribution; and
processes the audio streams dependent upon the correlation analysis to beat-match the at least two streams.

42. The device of claim 41, which:
determines an autocorrelation of the energy distribution of at least one of the audio streams; and
estimates a tempo of the audio stream from the autocorrelation.

43. The device of claim 41, which:
determines a cross-correlation between the energy distributions; and
aligns the tempi of at least two of the audio streams dependent upon the cross-correlation.

44. A device to beat-matching at least two audio streams, the device including a processor that:
means for determining an energy distribution of at least one audio stream;
means for performing a correlation analysis on the energy distribution; and
means for processing the audio streams dependent upon the correlation analysis to beat-match the at least two streams.
